(19) United States
(12) Patent Application Publication
(10) Pub. No.: US 2026/0142077 A1
(43) Pub. Date: May 21, 2026

(54) NEODYMIUM IRON BORON RING MAGNET FORMING APPARATUSES, NEODYMIUM IRON BORON RING MAGNETS AND METHODS OF PREPARING NEODYMIUM IRON BORON RING MAGNETS

(71) Applicant: BAOTOU RESEARCH INSTITUTE OF RARE EARTHS, Baotou (CN)

(72) Inventors: Jianlong Fu, Baotou (CN); Yanwei Song, Baotou (CN); Yan Gao, Baotou (CN); Deying Zhu, Baotou (CN); Dongbo Wang, Baotou (CN); Kai Qu, Baotou (CN); Haiyang Yu, Baotou (CN); Yu Wang, Baotou (CN); Wenliang Xie, Baotou (CN); Guozheng Liu, Baotou (CN); Fuqiang Lu, Baotou (CN)

(73) Assignee: BAOTOU RESEARCH INSTITUTE OF RARE EARTHS, Baotou (CN)

(21) Appl. No.: 19/390,346

(22) Filed: Nov. 14, 2025

(51) Int. Cl. H01F 41/02; H01F 1/057; H01F 7/02

(52) U.S. Cl. CPC H01F 41/0266; H01F 1/0576; H01F 7/0205

(57) ABSTRACT

The present disclosure provides a neodymium iron boron ring magnet forming apparatus, a neodymium iron boron ring magnet, and a method of preparing the neodymium iron boron ring magnet. The neodymium iron boron ring magnet forming apparatus comprises an upper punch, a female die, a lower outer punch, and a lower inner punch. The neodymium iron boron ring magnet forming apparatus can perform multiple steps, including cold pressing, hot pressing, pre-deformation, and hot deformation extrusion, and thus makes the process less complex, avoids repeated heating, and produces an NdFeB ring magnet with improved properties.

### TECHNICAL FIELD OF THE DISCLOSURE

The present disclosure relates to a neodymium iron boron ring magnet forming apparatus, and also relates to a neodymium iron boron ring magnet and a method of preparing the neodymium iron boron ring magnet.

### BACKGROUND OF THE DISCLOSURE

The process of making hot-deformed neodymium iron boron (NdFeB) radially oriented rings is near-net-shape manufacturing, so it is remarkably advantageous in producing small-sized, large-diameter, thin-walled, and high-performance ring magnets. Furthermore, a hot-deformed NdFeB radially oriented ring has a microstructure composed of nano-crystalline grains and thereby has superior magnetic properties at high temperatures. The current process of manufacturing hot-deformed NdFeB radially oriented rings primarily comprises three steps: cold pressing of a rapidly quenched NdFeB powder, hot pressing, and hot deformation extrusion. In existing technologies, these different steps typically require separate devices and corresponding molds, which complicates the process and increases production costs. Also, in current production processes, the cold-pressed compact made from a rapidly quenched NdFeB magnetic powder is first heated, and then subjected to the hot pressing step, resulting in an isotropic hot-pressed compact. After being cooled down, this compact is transferred to a hot deformation extruder where it must be reheated to an even higher temperature for hot deformation extrusion. This necessity for repeated heating of the sample leads the grains to be exposed to high temperatures for an extended period of time, which causes them to grow and leads to a product with degraded magnetic properties.

CN113996791A discloses a method of manufacturing a high-performance hot-pressed neodymium iron boron ring magnet, comprising: step S1 of a cold-pressing and pre-pressing step which subjects an NdFeB magnetic powder to cold pressing to form a cold compact; step S2 of a hot-pressing step which coats the surface of the cold compact evenly with a solution formed by a composite lubricant A, dries the cold compact, and then places it in a forming device for hot pressing to obtain a hot-pressed compact; and step S3 of a hot-deformation step which coats the surface of the hot-pressed compact with a solution formed by a composite lubricant B, dries the hot-pressed compact, and then places it in a forming device for hot deformation to obtain a radially oriented ring magnet. Although this process attains somewhat improved magnetic properties due to incorporating composite lubricants into the preparation, it still requires pressing in separate cold pressing and hot pressing/forming devices.

### SUMMARY OF THE DISCLOSURE

In view of the above, one objective of the present disclosure is to provide a neodymium iron boron ring magnet forming apparatus capable of performing multiple steps, including cold pressing, hot pressing, pre-deformation, and hot deformation extrusion, and thus making the process less complex, avoiding repeated heating, and producing an NdFeB ring magnet with improved properties. Another objective of the present disclosure is to provide a method of preparing an NdFeB ring magnet. Yet another objective of the present disclosure is to provide an NdFeB ring magnet.

The above objectives are accomplished by technical solutions described below.

One aspect of the present disclosure provides a neodymium iron boron ring magnet forming apparatus, comprising an upper punch, a female die, a lower outer punch, and a lower inner punch,
wherein the female die is provided, inside it, with a cavity configured to accommodate not only an NdFeB magnetic powder but also at least a portion of the upper punch, at least a portion of the lower outer punch, and at least a portion of the lower inner punch, and to comprise an upper cavity opening and a lower cavity opening;
the upper punch comprises an upper punch head, wherein the upper punch head has a diameter matching the diameter of the cavity of the female die, and is configured to extend into the cavity of the female die from the upper cavity opening and be movable up and down inside the cavity of the female die;
the lower outer punch comprises a lower outer punch head, wherein the lower outer punch head has an outer diameter less than or equal to the diameter of the female die, and is configured to extend into the cavity of the female die from the lower cavity opening and be movable up and down inside the cavity of the female die; and
the lower inner punch comprises a lower inner punch head, wherein the lower inner punch head has a diameter less than or equal to the inner diameter of the lower outer punch head, and is configured to extend into the cavity of the female die from the lower cavity opening and be movable up and down inside the cavity of the female die.

In the neodymium iron boron ring magnet forming apparatus of the present disclosure, preferably, the lower outer punch head comprises a first body and a second body, wherein the first body comprises a first body cavity and is configured to extend into the cavity of the female die from the lower cavity opening and be movable up and down inside the cavity of the female die, and the second body comprises a second body cavity and is configured to extend through the first body cavity and be movable up and down inside the first body cavity.

In the neodymium iron boron ring magnet forming apparatus of the present disclosure, preferably, the lower outer punch further comprises a first connection portion and a second connection portion, wherein the first connection portion is sleeved around the outer periphery of the bottom of the first body and located below the bottom of the female die, and the second connection portion is sleeved around the outer periphery of the bottom of the second body and located below the first connection portion.

In the neodymium iron boron ring magnet forming apparatus of the present disclosure, preferably, the lower inner punch further comprises a third connection portion, wherein the lower inner punch head is configured as a solid structure, the third connection portion is vertically connected to the bottom of the lower inner punch head, the lower inner punch head is configured to extend through the second body cavity and be movable up and down inside the second body cavity, and the third connection portion is located below the second connection portion.

In the neodymium iron boron ring magnet forming apparatus of the present disclosure, preferably, the outer diameter of the first body is equal to the diameter of the cavity of the female die, the diameter of the first body cavity is equal to the outer diameter of the second body, and the diameter of the second body cavity is equal to the diameter of the lower inner punch head.

In the neodymium iron boron ring magnet forming apparatus of the present disclosure, preferably, the height of the second body is greater than the height of the first body, the length of the second connection portion is less than the length of the first connection portion, the height of the lower inner punch head is greater than the height of the second body, and the length of the third connection portion is less than the length of the second connection portion.

Another aspect of the present disclosure provides a method of preparing a neodymium iron boron ring magnet using the neodymium iron boron ring magnet forming apparatus described above, comprising:
(1) inserting a portion of the first body, a portion of the second body, and a portion of the lower inner punch head into the cavity of the female die such that the upper end surface of the first body is flush with the upper end surface of the second body, while a distance is formed between the upper end surface of the lower inner punch head and the upper end surface of the first body to give a space where an NdFeB crude compact is placed; and moving the upper punch head downward until it comes into contact with the upper end surface of the first body and the upper end surface of the second body, and moving the lower inner punch head upward to press the NdFeB crude compact until the NdFeB crude compact has a density of 3.5-5.5 g/cm³, resulting in a cold-pressed compact;
(2) heating the cold-pressed compact to a temperature of 500-700° C., and moving the lower inner punch head upward again to press the cold-pressed compact at a pressure of 50-350 MPa for a duration of 10-500 s, so that the cold-pressed compact has a density of 7.0 g/cm³ or more, resulting in a hot-pressed compact;
(3) moving the second body downward until it is flush with the upper end surface of the lower inner punch head, heating the hot-pressed compact to a temperature of 700-800° C., and moving the second body and the lower inner punch head upward simultaneously to press the hot-pressed compact at a pressure of 100-300 MPa for a duration of 10-500 s, resulting in a first pre-deformed compact in the first body cavity;
(4) heating the first pre-deformed compact to a temperature of 800-950° C., keeping it at that temperature for a duration of 30-500 s, moving the first body downward until it is flush with the upper end surface of the second body and the upper end surface of the lower inner punch head, and immobilizing the first body, the second body, and the lower inner punch head, while moving the upper punch head downward to press the first pre-deformed compact at a pressure of 50-500 MPa for a duration of 10-500 s, resulting in a ring magnet precursor in the female die; and
(5) immobilizing the second body and the lower inner punch head while moving the upper punch head downward to slowly press the ring magnet precursor at a pressure of 120-300 MPa and a speed of 0.01-10 mm/s, while pressing, by the first body, the lower edge of the ring magnet precursor at a pressure of less than 50 MPa.

In the method of the present disclosure, preferably, step (1) further comprises: applying a release agent to the side and bottom surfaces of the upper punch head, the first body and the second body and to the cavity of the female die, wherein the release agent is a homogeneous mixture of a molybdenum disulfide powder and a graphite powder at a mass ratio of 1:1-3.

The method of the present disclosure preferably further comprises:
rapidly withdrawing the upper punch head from the cavity of the female die, moving the second body and the lower inner punch head downward until they are flush with the upper end surface of the first body, and moving the first body, the second body, and the lower inner punch head upward simultaneously until they are flush with the upper edge of the female die, leading to release of a hot-deformed neodymium iron boron ring magnet.

Yet another aspect of the present disclosure provides a neodymium iron boron ring magnet prepared by the method described above.

The neodymium iron boron ring magnet forming apparatus of the present disclosure can carry out multiple steps, including cold pressing, hot pressing, pre-deformation, and hot deformation extrusion, and thereby makes the process less complex, avoids repeated heating, and enables pre-pressing deformation. Therefore, it can produce an NdFeB ring magnet with improved properties.

### BRIEF SUMMARY OF THE DRAWINGS

FIG. 1 is a schematic structural diagram of a neodymium iron boron ring magnet forming apparatus according to the present disclosure.

FIG. 2 is a schematic diagram of the neodymium iron boron ring magnet forming apparatus according to the present disclosure in the course of cold pressing and hot pressing.

FIG. 3 is a schematic diagram of the neodymium iron boron ring magnet forming apparatus according to the present disclosure in the course of first pre-deformation.

FIG. 4 is a schematic diagram of the neodymium iron boron ring magnet forming apparatus according to the present disclosure in the course of second pre-deformation.

FIG. 5 is a schematic diagram of the neodymium iron boron ring magnet forming apparatus according to the present disclosure in the course of extrusion.

The reference numerals of the components are as follows:
1: upper punch, 11: upper punch head; 2: female die; 3: lower outer punch, 311: first body, 312: first connection portion, 321: second body, 322: second connection portion; 4: lower inner punch, 41: lower inner punch head, 42: third connection portion;
100: hot-pressed compact; 200: first pre-deformed compact; 300: ring magnet precursor; 400: hot-deformed NdFeB ring magnet.

### DETAIL DESCRIPTION OF THE DISCLOSURE

The following is a further description of the present disclosure by means of embodiments, but the present disclosure is not limited to those embodiments.

### <NdFeB Ring Magnet Forming Apparatus>

The neodymium iron boron ring magnet forming apparatus of the present disclosure comprises an upper punch, a female die, a lower outer punch, and a lower inner punch.

### Female Die

The female die of the present disclosure, as a place for forming a neodymium iron boron ring magnet, is provided, inside it, with a cavity that can accommodate not only an NdFeB magnetic powder but also at least a portion of the upper punch, at least a portion of the lower outer punch, and at least a portion of the lower inner punch, and that has an upper cavity opening and a lower cavity opening.

### Upper Punch

The upper punch is located above the female die and configured as a solid structure. The cross-section of the upper punch is generally T-shaped. The upper punch comprises an upper punch head. The upper punch head has a diameter equal to the diameter of the cavity of the female die, and is configured to extend into the cavity of the female die from the upper cavity opening and be movable up and down inside the cavity of the female die. The upper punch functions to press an NdFeB crude compact from above and withdraw from the upper cavity opening of the female die upon completion of the pressing.

### Lower Outer Punch

The lower outer punch comprises a lower outer punch head. The lower outer punch head is movable up and down inside the female die and functions to press the NdFeB crude compact from below and withdraw from the upper cavity opening of the female die upon completion of the pressing.

The lower outer punch may comprise a first body and a second body. The first body comprises a first body cavity and is configured to extend into the cavity of the female die from the lower cavity opening and be movable up and down inside the cavity of the female die, and the second body comprises a second body cavity and is configured to extend through the first body cavity and be movable up and down inside the first body cavity.

The lower outer punch may comprise a first connection portion and a second connection portion. The first connection portion is sleeved around the outer periphery of the bottom of the first body and located below the bottom of the female die, and the second connection portion is sleeved around the outer periphery of the bottom of the second body and located below the first connection portion. The first connection portion and the second connection portion can connect the first body and the second body to their corresponding structures.

In the present disclosure, the outer diameter of the first body is equal to the diameter of the cavity of the female die, and the diameter of the first body cavity is equal to the outer diameter of the second body.

In the present disclosure, the height of the second body is greater than the height of the first body, and the length of the second connection portion is less than the length of the first connection portion.

### Lower Inner Punch

The lower inner punch may comprise a lower inner punch head and a third connection portion. The lower inner punch head and the third connection portion are each configured as a solid structure and vertically connected to each other. The cross-section of the lower inner punch is generally T-shaped. The third connection portion is vertically connected to the bottom of the lower inner punch head. The lower inner punch head is configured to extend through the second body cavity and be movable up and down inside the second body cavity. The third connection portion is located below the second connection portion.

In the present disclosure, the diameter of the lower inner punch head is equal to the diameter of the second body cavity.

In the present disclosure, the height of the lower inner punch head is greater than the height of the second body, and the length of the third connection portion is less than the length of the second connection portion.

The diameter of the upper punch head may be 30-60 mm, preferably 33-55 mm, and more preferably 35-52 mm. The diameter of the cavity of the female die may be 30-60 mm, preferably 33-55 mm, and more preferably 35-52 mm. In some embodiments, the diameter of the upper punch head is 38 mm, and the diameter of the cavity of the female die is 38 mm. In other embodiments, the diameter of the upper punch head is 50.8 mm, and the diameter of the cavity of the female die is 50.8 mm.

The diameter of the first body cavity may be 25-50 mm, preferably 28-48 mm, and more preferably 30-45 mm. The outer diameter of the second body may be 25-50 mm, preferably 28-48 mm, and more preferably 30-45 mm. In some embodiments, the diameter of the first body cavity is 30.2 mm, and the outer diameter of the second body is 30.2 mm. In other embodiments, the diameter of the first body cavity is 44.8 mm, and the outer diameter of the second body is 44.8 mm.

The diameter of the lower inner punch head may be 15-35 mm, preferably 16-32 mm, and more preferably 17-28 mm. The diameter of the second body cavity may be 15-35 mm, preferably 16-32 mm, and more preferably 17-28 mm. In some embodiments, the diameter of the lower inner punch head is 17 mm, and the diameter of the second body cavity is 17 mm. In other embodiments, the diameter of the lower inner punch head is 27.8 mm, and the diameter of the second body cavity is 27.8 mm.

### <Method of Preparing NdFeB Ring Magnet>

The NdFeB ring magnet of the present disclosure is prepared with the forming apparatus described above and by a method comprising a cold pressing step, a hot pressing step, a first pre-deformation step, a second pre-deformation step, and an extrusion step. In some embodiments, the method further comprises a pretreatment step and a release step. All the steps can be completed on a single apparatus, which will be described in detail below.

### Pretreatment

In the present disclosure, the entire chamber of a hot press is sealed and evacuated, followed by being filled with argon. The chamber of the hot press is repeatedly purged with argon such that it contains oxygen in a content of less than 50 ppm, preferably less than 30 ppm.

In the present disclosure, a release agent may be applied to the side and bottom surfaces of the upper punch head, the first body and the second body and to the cavity of the female die. The release agent is a homogeneous mixture of a molybdenum disulfide powder and a graphite powder. The mass ratio of the molybdenum disulfide powder to the graphite powder may be 1:1-3, preferably 1:1-2, and more preferably 1:1.

### Cold Pressing

Cold pressing refers to the process of pressing a crude compact without heating it.

A portion of the first body, a portion of the second body, and a portion of the lower inner punch head are inserted into the cavity of the female die such that the upper end surface of the first body is flush with the upper end surface of the second body, while a distance is formed between the upper end surface of the lower inner punch head and the upper end surface of the first body to give a space where the NdFeB crude compact is placed. The upper punch head is then moved downward until it is flush with (i.e., comes into contact with) the upper end surfaces of the first body and the second body, and the lower inner punch head is moved upward again to press the NdFeB crude compact. The pressing is stopped when the density of the NdFeB crude compact arrives at 3.5-5.5 g/cm³, resulting in a cold-pressed compact.

In this step, the upper punch head comes into contact with the upper end surfaces of the first and second bodies, while the upper end surface of the lower inner punch head remains below the the upper punch head and the first and second bodies. This ensures that the crude compact is pushed into the second body cavity and thereby pressed solely in the second body cavity.

The NdFeB crude compact may contain praseodymium, neodymium, iron, cobalt, gallium, and boron. The total content of praseodymium and neodymium is preferably 25-32 wt %, more preferably 29-31 wt %. The content of iron is preferably 60-65 wt %, more preferably 63-65 wt %. The content of cobalt is preferably 2-6 wt %, more preferably 3.5-5.5 wt %. The content of gallium is preferably 0.3-0.6 wt %, more preferably 0.4-0.55 wt %. The content of boron may be less than 1 wt %, preferably 0.8-0.96 wt %, and more preferably 0.9-0.95 wt %.

The density of the cold-pressed compact may be 3.5-5.5 g/cm³, preferably 3.5-4.5 g/cm³, and more preferably 3.8-4.2 g/cm³.

### Hot Pressing

The cold-pressed compact is heated to a temperature of 500-700° C., and the lower inner punch head is moved upward again to press the cold-pressed compact at a pressure of 50-350 MPa for a duration of 10-500 s, so that the density of the cold-pressed compact arrives at 7.0 g/cm³ or more, resulting in a hot-pressed compact.

The temperature for the hot pressing may be 500-700° C., preferably 550-650° C., and more preferably 600-650° C.

The pressure applied during the hot pressing may be 50-350 MPa, preferably 100-350 MPa, and more preferably 200-350 MPa.

The duration for the hot pressing may be 10-500 s, preferably 20-50 s, and more preferably 25-35 s.

The density of the hot-pressed compact may be greater than 7.0 g/cm³, preferably greater than 7.3 g/cm³, and more preferably greater than 7.5 g/cm³.

### First Pre-Deformation

The second body is moved downward until it is flush with the upper end surface of the lower inner punch head. The hot-pressed compact is then heated to a temperature of 700-800° C. The second body and the lower inner punch head are moved upward simultaneously to press the hot-pressed compact at a pressure of 100-300 MPa for a duration of 10-500 s, resulting in a first pre-deformed compact in the first body cavity.

In this step, the upper punch head and the first body are immobilized while the second body is moved downward until it is flush with the upper end surface of the lower inner punch head. This ensures that the hot-pressed compact is pressed in the first body cavity.

The temperature for the first pre-deformation is 700-800° C., preferably 720-780° C., and more preferably 720-750° C.

The pressure applied during the first pre-deformation is 100-300 MPa, preferably 120-280 MPa, and more preferably 150-250 MPa.

The duration for pressing the hot-pressed compact is 10-500 s, preferably 20-40 s, and more preferably 25-35 s.

### Second Pre-Deformation

The first pre-deformed compact is heated to 800-950° C. and kept at that temperature for 30-500 s. The first body is moved downward until it is flush with the upper end surface of the second body and the upper end surface of the lower inner punch head. The first body, second body, and lower inner punch head are immobilized while the upper punch head is moved downward to press the first pre-deformed compact at a pressure of 50-500 MPa for a duration of 10-500 s, resulting in a ring magnet precursor in the cavity of the female die.

In this step, moving the first body downward until it is flush with the upper end surfaces of both the second body and the lower inner punch head ensures that the first pre-deformed compact is pressed in the cavity of the female die.

The temperature for the second pre-deformation may be 800-950° C., preferably 800-900° C., and more preferably 820-850° C.

The time for keep the first pre-deformed compact may be 30-500 s, preferably 30-100 s, and more preferably 50-80 s.

The pressure for the second pre-deformation may be 50-500 MPa, preferably 100-450 MPa, and more preferably 150-400 MPa.

The duration for pressing the first pre-deformed compact may be 10-500 s, preferably 20-40 s, and more preferably 25-35 s.

In conventional techniques, different steps are carried out in separate devices, and the sample obtained from a previous step must be cooled and transferred to another device, where the sample is reheated to a required temperature. Such repeated cooling and heating may easily lead to a ring magnet with degraded magnetic properties. In the present disclosure, the temperature gradually increases from the hot pressing step to the first and second pre-deformation steps. This allows direct heating from one step to the next, avoiding repetitive operations (heating→cooling→reheating) and thereby resulting in an NdFeB ring magnet with improved magnetic properties.

### Extrusion

The second body and the lower inner punch head are immobilized, while the upper punch head is moved downward to slowly press the ring magnet precursor at a pressure of 120-300 MPa and a speed of 0.01-10 mm/s. Meanwhile, the first body presses the lower edge of the ring magnet precursor. The pressure applied by the first body is less than 50 MPa.

In this step, the upper punch presses the ring magnet precursor downward, while the first body presses its lower edge. This ensures that the first body can passively move downward during the extrusion.

The pressure applied by the upper punch head may be 120-300 MPa, preferably 150-250 MPa, and more preferably 150-200 MPa.

The speed at which the upper punch head presses the ring magnet precursor may be 0.01-10 mm/s, preferably 0.05-5 mm/s, and more preferably 0.08-2 mm/s.

The pressure at which the first body presses the ring magnet precursor may be less than 50 MPa, preferably less than 10 MPa, and more preferably less than 5 MPa.

### Release

The upper punch head is quickly withdrawn from the cavity of the female die. The second body and the lower inner punch head are moved downward until they are flush with the upper end surface of the first body. The first body, the second body, and the lower inner punch head are moved upward simultaneously until they are flush with the upper edge of the female die, leading to release of an NdFeB ring magnet.

### <NdFeB Ring Magnet>

The NdFeB ring magnet of the present disclosure is prepared by the method described above.

### Example 1

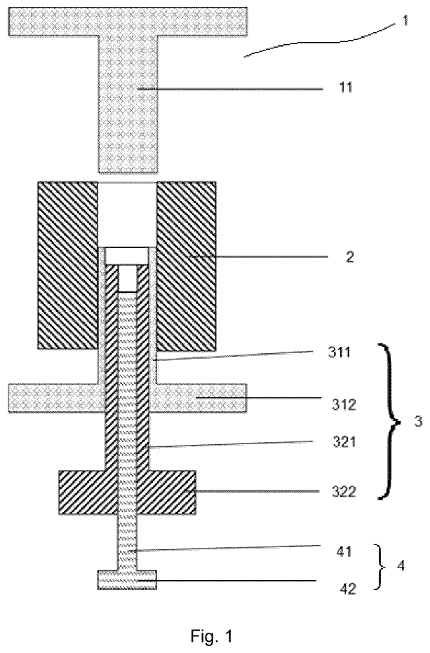

As shown in FIG. 1, an NdFeB ring magnet forming apparatus of this example comprises an upper punch 1, a female die 2, a lower outer punch 3, and a lower inner punch 4.

The female die 2 is provided with a cavity for accommodating an NdFeB magnetic powder and at least a portion of the upper punch 1, at least a portion of the lower outer punch 3, and at least a portion of the lower inner punch 4. The cavity of the female die 2 comprises an upper cavity opening and a lower cavity opening.

The upper punch 1 comprises an upper punch head 11, and the cross-section of the upper punch 1 is generally T-shaped. The upper punch head 11 is a solid structure. The diameter of the upper punch head 11 is equal to the diameter of the cavity of the female die 2. The upper punch head 11 can extend into the cavity of the female die 2 from the upper cavity opening and is movable up and down inside the cavity of the female die 2.

The lower outer punch 3 comprises a first body 311, a first connection portion 312, a second body 321, and a second connection portion 322.

The first body 311 comprises a first body cavity. The first body 311 can extend into the cavity of the female die 2 from the lower cavity opening and is movable up and down inside the cavity. The first connection portion 312 is sleeved around the outer periphery of the bottom of the first body 311. The first connection portion 312 is located below the bottom of the female die 2.

The second body 321 comprises a second body cavity. The second body 321 can extend into the cavity of the female die 2 from the lower cavity opening and is movable up and down inside the cavity. Specifically, the second body 321 extends through the first body cavity and is movable up and down inside the first body cavity. The second connection portion 322 is sleeved around the outer periphery of the bottom of the second body 321. The second connection portion 322 is located below the first connection portion 312. The outer diameter of the second body 321 matches the diameter of the first body cavity. The height of the second body 321 is greater than the height of the first body 311, and the length of the second connection portion 322 is less than the length of the first connection portion 312.

The lower inner punch 4 comprises a lower inner punch head 41 and a third connection portion 42. The third connection portion 42 is vertically connected to the bottom of the lower inner punch head 41. The cross-section of the lower inner punch 4 is generally T-shaped. The lower inner punch head 41 is a solid structure. The lower inner punch head 41 can extend into the cavity of the female die 2 from the lower cavity opening and is movable up and down inside the cavity of the female die 2. The third connection portion 42 is located below the second connection portion 322. Specifically, the lower inner punch head 41 extends through the second body cavity. The diameter of the lower inner punch head 41 is equal to the diameter of the second body cavity. The height of the lower inner punch head 41 is greater than the height of the second body 321, and the length of the third connection portion 42 is less than the length of the second connection portion 322.

In this example, the diameter of the upper punch head 11, the diameter of the cavity of the female die 2, and the outer diameter of the first body 311 are all 50.8 mm. The diameter of the first body cavity and the outer diameter of the second body 321 are both 44.8 mm. The diameter of the lower inner punch head 41 and the diameter of the second body cavity are both 27.8 mm.

### Example 2

In this example, except that the diameter of the upper punch head 11, the diameter of the cavity of the female die 2, and the outer diameter of the first body 311 are all 38 mm, the diameter of the first body cavity and the outer diameter of the second body 321 are both 30.2 mm, and the diameter of the lower inner punch head 41 and the diameter of the second body cavity are both 17 mm, all the other features are the same as in Example 1.

### Example 3

An NdFeB ring magnet was prepared from an NdFeB crude compact with the apparatus of Example 1.

The NdFeB crude compact was composed of 30.6 wt % Pr and Nd (with a mass ratio of Pr to Nd being 25:75), 62.98 wt % Fe, 5 wt % Co, 0.5 wt % Ga, and 0.92 wt % B.

The process included the following steps:
The entire chamber of the hot press was sealed and evacuated, followed by being filled with argon. The chamber of the hot press was repeatedly purged with argon such that it contained oxygen in a content of less than 50 ppm.

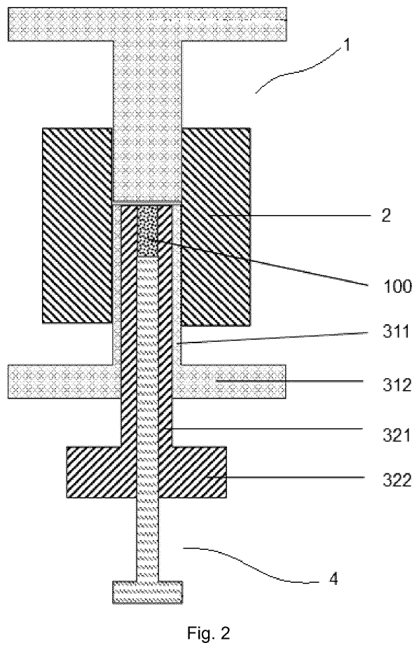

As shown in FIGS. 1 and 2, a release agent was applied to the side and bottom surfaces of the upper punch head 11, the first body 311 and the second body 321 and to the cavity of the female die 2. The release agent was a homogeneous mixture of a molybdenum disulfide powder and a graphite powder at a ratio of 1:1. A portion of the first body 311, a portion of the second body 321, and a portion of the lower inner punch head 41 were inserted into the cavity of the female die 2 such that the upper end surface of the first body 311 was flush with the upper end surface of the second body 321, and the upper end surface of the lower inner punch head 41 was lower than the upper end surfaces of both the first body 311 and the second body 321. A distance is thus formed between the upper end surface of the lower inner punch head 41 and the upper end surface of the first body 311, giving a space where the NdFeB crude compact was placed. Then, the upper punch head 11 was moved downward until it is flush with (i.e., comes into contact with) the upper end surfaces of the first body 311 and the second body 321, and the lower inner punch 4 was moved upward to press the NdFeB crude compact. The pressing was stopped when the density of the NdFeB crude compact arrived at 4.0 g/cm³, resulting in a cold-pressed compact.

The cold-pressed compact was heated to a temperature of 600° C., and the lower inner punch 4 was moved upward again to press the cold-pressed compact at a pressure of 200 MPa for a duration of 30 s. The pressing was stopped when the density of the cold-pressed compact arrived at 7.3 g/cm³, resulting in a hot-pressed compact 100.

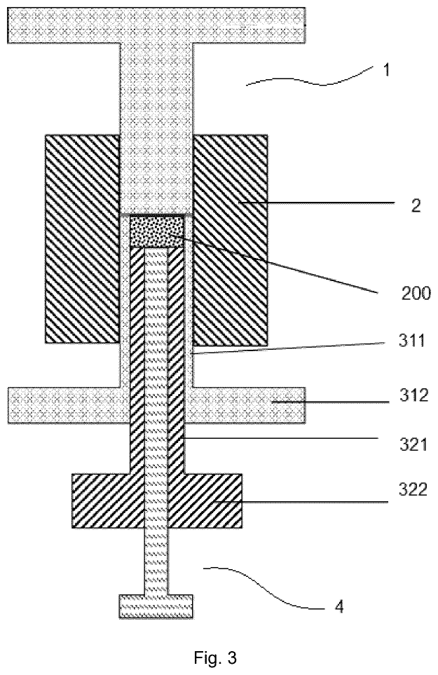

As shown in FIGS. 2 and 3, the second body 321 was moved downward until its upper end surface was flush with the upper end surface of the lower inner punch head 41. The hot-pressed compact 100 was heated to 720° C., and then the second body 321 and the lower inner punch head 41 were moved upward simultaneously to press the hot-pressed compact 100 at a pressure of 200 MPa for a duration of 30 s, resulting in a first pre-deformed compact 200 in the first body cavity.

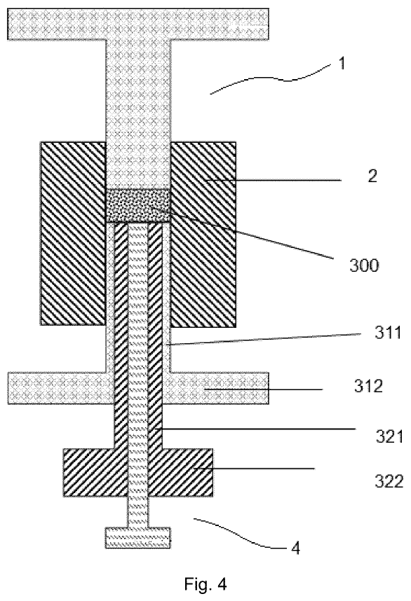

As shown in FIGS. 3 and 4, the first pre-deformed compact 200 was further heated to 820° C. and kept at that temperature for 60 s. The first body 311 was moved downward until its upper end surface was flush with the upper end surfaces of the second body 321 and the lower inner punch head 41. The first body 311, the second body 321, and the lower inner punch head 41 were immobilized, while the upper punch head 11 was moved downward to press the first pre-deformed compact 200 at a pressure of 150 MPa for a duration of 30 s, resulting in a ring magnet precursor 300 in the female die 2.

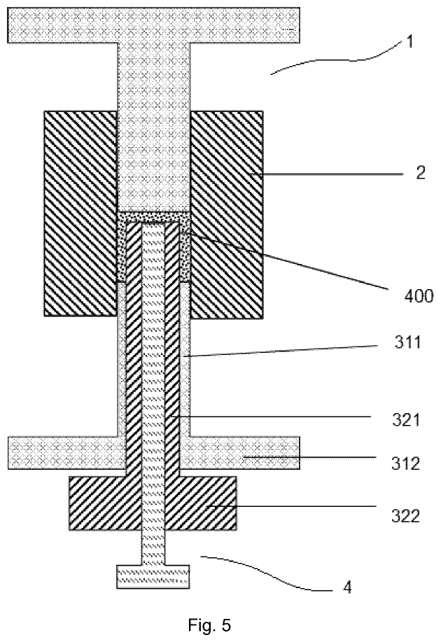

As shown in FIGS. 4 and 5, the second body 321 and the lower inner punch head 41 were immobilized, and the first body 311 applied a pressure of less than 5 MPa to the ring magnet precursor 300. The upper punch head 11 was then moved downward to slowly press the ring magnet precursor 300 at a pressure of 150 MPa and a speed of 0.1 mm/s. Due to the low pressure applied to the first body 311, it moved downward during the extrusion of the ring magnet precursor 300.

After the extrusion was completed, the upper punch head 11 was quickly withdrawn from the cavity of the female die 2. The second body 321 and the lower inner punch head 41 were moved downward until they were flush with the upper end surface of the first body 311. The first body 311, the second body 321, and the lower inner punch head 41 were moved upward simultaneously until they are flush with the upper edge of the female die 2, leading to release of a hot-deformed NdFeB ring magnet 400.

### Example 4

An NdFeB ring magnet was prepared from an NdFeB crude compact with the apparatus of Example 2.

The NdFeB crude compact was composed of 29.8 wt % Pr and Nd (with a mass ratio of Pr to Nd being 25:75), 64.83 wt % Fe, 4 wt % Co, 0.45 wt % Ga, and 0.92 wt % B.

The process included the following steps:
The entire chamber of the hot press was sealed and evacuated, followed by being filled with argon. The chamber of the hot press was repeatedly purged with argon such that it contained oxygen in a content of less than 30 ppm.

As shown in FIGS. 1 and 2, a release agent was applied to the side and bottom surfaces of the upper punch head 11, the first body 311 and the second body 321 and to the cavity of the female die 2. The release agent was a homogeneous mixture of a molybdenum disulfide powder and a graphite powder at a ratio of 1:1. A portion of the first body 311, a portion of the second body 321, and a portion of the lower inner punch head 41 were inserted into the cavity of the female die 2 such that the upper end surface of the first body 311 was flush with the upper end surface of the second body 321, and the upper end surface of the lower inner punch head 41 was lower than the upper end surfaces of both the first body 311 and the second body 321. A distance is thus formed between the upper end surface of the lower inner punch head 41 and the upper end surface of the first body 311, giving a space where the NdFeB crude compact was placed. Then, the upper punch head 11 was moved downward until it is flush with (i.e., comes into contact with) the upper end surfaces of the first body 311 and the second body 321, and the lower inner punch 4 was moved upward to press the NdFeB crude compact. The pressing was stopped when the density of the NdFeB crude compact arrived at 4.0 g/cm³, resulting in a cold-pressed compact.

The cold-pressed compact was heated to a temperature of 650° C., and the lower inner punch 4 was moved upward again to press the cold-pressed compact at a pressure of 350 MPa for a duration of 30 s. The pressing was stopped when the density of the cold-pressed compact arrived at 7.5 g/cm³, resulting in a hot-pressed compact 100.

As shown in FIGS. 2 and 3, the second body 321 was moved downward until its upper end surface was flush with the upper end surface of the lower inner punch head 41. The hot-pressed compact 100 was heated to 750° C., and then the second body 321 and the lower inner punch head 41 were moved upward simultaneously to press the hot-pressed compact 100 at a pressure of 200 MPa for a duration of 30 s, resulting in a first pre-deformed compact 200 in the first body cavity.

As shown in FIGS. 3 and 4, the first pre-deformed compact 200 was further heated to 850° C. and kept at that temperature for 60 s. The first body 311 was moved downward until its upper end surface was flush with the upper end surfaces of the second body 321 and the lower inner punch head 41. The first body 311, the second body 321, and the lower inner punch head 41 were immobilized, while the upper punch head 11 was moved downward to press the first pre-deformed compact 200 at a pressure of 150 MPa for a duration of 30 s, resulting in a ring magnet precursor 300 in the female die 2.

As shown in FIGS. 4 and 5, the second body 321 and the lower inner punch head 41 were immobilized, and the first body 311 applied a pressure of less than 10 MPa to the ring magnet precursor 300. The upper punch head 11 was then moved downward to slowly press the ring magnet precursor 300 at a pressure of 200 MPa and a speed of 0.1 mm/s. Due to the low pressure applied to the first body 311, it moved downward during the extrusion of the ring magnet precursor 300.

After the extrusion was completed, the upper punch head 11 was quickly withdrawn from the cavity of the female die 2. The second body 321 and the lower inner punch head 41 were moved downward until they were flush with the upper end surface of the first body 311. The first body 311, the second body 321, and the lower inner punch head 41 were moved upward simultaneously until they are flush with the upper edge of the female die 2, leading to release of a hot-deformed NdFeB ring magnet 400.

### Comparative Example 1

An NdFeB ring magnet was obtained by subjecting an NdFeB crude compact of the same composition as in Example 3 of the present disclosure to the cold-pressing and pre-pressing step, hot-pressing step, and hot-deformation step described in the method of Example 1 of CN113996791A.

### Comparative Example 2

An NdFeB ring magnet was obtained by subjecting an NdFeB crude compact of the same composition as in Example 4 of the present disclosure to the cold-pressing and pre-pressing step, hot-pressing step, and hot-deformation step described in the method of Example 1 of CN113996791A.

The hot-deformed NdFeB ring magnets obtained from Example 3, Example 4, and Comparative Examples 1 and 2 were tested by the following method:

The magnets were cut into 2×2×2 mm cubic specimens by a wire Electrical Discharge Machining (EDM) machine. The magnetic properties of the magnets, including remanence (Bᵣ), maximum magnetic energy product ((BH)ₘₐₓ), and intrinsic coercivity (H_{cj}), were measured by a vibrating sample magnetometer.

The results of the measurement are shown in Table 1.

TABLE 1

| | Intrinsic | | Maximum Energy |
|---|---|---|---|
| | Coercivity H_{cj} | Remanence Br | Product (BH)ₘₐₓ |
| | (kOe) | (kGs) | (MGOe) |
| Example 3 | 14.78 | 13.42 | 42.33 |
| Com. Ex. 1 | 14.48 | 12.87 | 38.39 |
| Example 4 | 14.17 | 13.66 | 43.75 |
| Com. Ex. 2 | 13.48 | 13.03 | 39.24 |

The present disclosure is not limited to the embodiments described above. Any variation, improvement, and replacement which do not depart from the essence of the present disclosure and which those skilled in the art are able to think of fall within the scope of the present disclosure.

What is claimed is:

1. A neodymium iron boron ring magnet forming apparatus, comprising an upper punch, a female die, a lower outer punch, and a lower inner punch,
wherein the female die is provided, inside it, with a cavity configured to accommodate an NdFeB magnetic powder, at least a portion of the upper punch, at least a portion of the lower outer punch, and at least a portion of the lower inner punch, and to comprise an upper cavity opening and a lower cavity opening;
the upper punch comprises an upper punch head, wherein the upper punch head has a diameter matching the diameter of the cavity of the female die, and is configured to extend into the cavity of the female die from the upper cavity opening and be movable up and down inside the cavity of the female die;
the lower outer punch comprises a lower outer punch head, wherein the lower outer punch head has an outer diameter less than or equal to the diameter of the female die, and is configured to extend into the cavity of the female die from the lower cavity opening and be movable up and down inside the cavity of the female die; and
the lower inner punch comprises a lower inner punch head, wherein the lower inner punch head has a diameter less than or equal to the inner diameter of the lower outer punch head, and is configured to extend into the cavity of the female die from the lower cavity opening and be movable up and down inside the cavity of the female die.

2. The neodymium iron boron ring magnet forming apparatus according to claim 1, wherein the lower outer punch head comprises a first body and a second body, wherein the first body comprises a first body cavity and is configured to extend into the cavity of the female die from the lower cavity opening and be movable up and down inside the cavity of the female die, and the second body comprises a second body cavity and is configured to extend through the first body cavity and be movable up and down inside the first body cavity.

3. The neodymium iron boron ring magnet forming apparatus according to claim 2, wherein the lower outer punch further comprises a first connection portion and a second connection portion, wherein the first connection portion is sleeved around the outer periphery of the bottom of the first body and located below the bottom of the female die, and the second connection portion is sleeved around the outer periphery of the bottom of the second body and located below the first connection portion.

4. The neodymium iron boron ring magnet forming apparatus according to claim 3, wherein the lower inner punch further comprises a third connection portion, wherein the lower inner punch head is configured as a solid structure, the third connection portion is vertically connected to the bottom of the lower inner punch head, the lower inner punch head is configured to extend through the second body cavity and be movable up and down inside the second body cavity, and the third connection portion is located below the second connection portion.

5. The neodymium iron boron ring magnet forming apparatus according to claim 4, wherein the outer diameter of the first body is equal to the diameter of the cavity of the female die, the diameter of the first body cavity is equal to the outer diameter of the second body, and the diameter of the second body cavity is equal to the diameter of the lower inner punch head.

6. The neodymium iron boron ring magnet forming apparatus according to claim 5, wherein the height of the second body is greater than the height of the first body, the length of the second connection portion is less than the length of the first connection portion, the height of the lower inner punch head is greater than the height of the second body, and the length of the third connection portion is less than the length of the second connection portion.

7. A method of preparing a neodymium iron boron ring magnet using the neodymium iron boron ring magnet forming apparatus according to claim 2, comprising:
(1) inserting a portion of the first body, a portion of the second body, and a portion of the lower inner punch head into the cavity of the female die such that the upper end surface of the first body is flush with the upper end surface of the second body, while a distance is formed between the upper end surface of the lower inner punch head and the upper end surface of the first body to give a space where an NdFeB crude compact is placed; and moving the upper punch head downward until it comes into contact with the upper end surface of the first body and the upper end surface of the second body, and moving the lower inner punch head upward to press the NdFeB crude compact until the NdFeB crude compact has a density of 3.5-5.5 g/cm³, resulting in a cold-pressed compact;
(2) heating the cold-pressed compact to a temperature of 500-700° C., and moving the lower inner punch head upward again to press the cold-pressed compact at a pressure of 50-350 MPa for a duration of 10-500 s, so that the cold-pressed compact has a density of 7.0 g/cm³ or more, resulting in a hot-pressed compact;
(3) moving the second body downward until it is flush with the upper end surface of the lower inner punch head, heating the hot-pressed compact to a temperature of 700-800° C., and moving the second body and the lower inner punch head upward simultaneously to press the hot-pressed compact at a pressure of 100-300 MPa for a duration of 10-500 s, resulting in a first pre-deformed compact in the first body cavity;
(4) heating the first pre-deformed compact to a temperature of 800-950° C., keeping it at that temperature for a duration of 30-500 s, moving the first body downward until it is flush with the upper end surface of the second body and the upper end surface of the lower inner punch head, and immobilizing the first body, the second body, and the lower inner punch head, while moving the upper punch head downward to press the first pre-deformed compact at a pressure of 50-500 MPa for a duration of 10-500 s, resulting in a ring magnet precursor in the female die; and
(5) immobilizing the second body and the lower inner punch head while moving the upper punch head downward to slowly press the ring magnet precursor at a pressure of 120-300 MPa and a speed of 0.01-10 mm/s, while pressing, by the first body, the lower edge of the ring magnet precursor at a pressure of less than 50 MPa.

8. The method according to claim 7, wherein step (1) further comprises:
applying a release agent to the side and bottom surfaces of the upper punch head, the first body and the second body and to the cavity of the female die, wherein the release agent is a homogeneous mixture of a molybdenum disulfide powder and a graphite powder at a mass ratio of 1:1-3.

9. The method according to claim 8, further comprising:
rapidly withdrawing the upper punch head from the cavity of the female die, moving the second body and the lower inner punch head downward until they are flush with the upper end surface of the first body, and moving the first body, the second body, and the lower inner punch head upward simultaneously until they are flush with the upper edge of the female die, leading to release of a neodymium iron boron ring magnet.

10. A neodymium iron boron ring magnet prepared by the method according to claim 7.
